(19) United States
(12) Patent Application Publication
(10) Pub. No.: US 2011/0053426 A1
(43) Pub. Date: Mar. 3, 2011

(54) LOWER PROFILE ELECTRICAL CONTACT AND ELECTRICAL SOCKET USING THE SAME

(75) Inventors: CHIH-PI CHENG, Tu-Cheng (TW); JIA-HAU LIU, Tu-Cheng (TW)

(73) Assignee: HON HAI PRECISION INDUSTRY CO., LTD., Tu-Cheng (TW)

(21) Appl. No.: 12/875,142

(22) Filed: Sep. 3, 2010

(30) Foreign Application Priority Data
Sep. 3, 2009 (TW) 98216234

(51) Int. Cl. H01R 4/48; H01R 24/00

(52) U.S. Cl. 439/660; 439/862

(57) ABSTRACT

An electrical contact comprises a blade serving a number of retaining portions thereon; and a spring arm extending parallel to the blade and attached to the blade by a curved portion so that a contacting space is formed between the spring arm and the blade for receiving and engaging with a pin leg of an electronic component. The electrical contact has a lower profile. The electrical socket incorporated with such contacts is benefited with low profile suitable for compact and thin applications.

### BACKGROUND OF THE INVENTION

1. Field of the Invention

The present invention relates to an electrical contact and an electrical socket using the same, and more particularly to an electrical contact having a lower profile structure and an electrical socket having the same lower profile contacts thereby lowering and benefiting an overall height of the socket for compact application.

2. Description of Prior Art

U.S. Pat. No. 6,554,634 issued to Liao on Apr. 29, 2003 discloses a conventional electrical contact and electrical socket for electrically connecting a pin of an electrical package and a PCB (printed circuit board). The electrical contact 1 of the electrical socket comprises a base portion 10 extending in a vertical direction, an engaging portion 11 extending from a top end of the base portion 10, and a solder pad 12 extending from a bottom end of the base portion 10. The engaging portion 11 and the solder pad 12 also extend along the vertical direction.

However, such conventional contact may not be useful in certain application, such a thin and compact environment. The base portion, engaging portion and the solder pad are disposed at positions having different heights relative to a same horizontal plane. In other words, the three portions are disposed at different horizontal plane. Therefore, the whole height of the electrical contact is bulky for the above-described application. Accordingly, it is inevitable that a socket incorporated with such contact will also featured with a bulky dimension not suitable for compact and thin application.

In view of the above, an improved electrical contact and electrical socket that overcomes the above-mentioned disadvantages is desired.

### SUMMARY OF THE INVENTION

Accordingly, an object of the present invention is to provide a low profile contact terminal and an electrical socket incorporated with such contacts is also benefited with low profile suitable for compact and thin applications.

To achieve the above-mentioned object, an electrical contact and an electrical socket incorporated with such contacts are provided. The electrical contact comprises a blade serving a number of retaining portions thereon; and a spring arm extending parallel to the blade and attached to the blade by a curved portion so that a contacting space is formed between the spring arm and the blade for receiving and engaging with a pin leg of an electronic component. The electrical socket is incorporated with a plurality of same contacts. The electrical contact has a lower profile and the electrical socket incorporated with such contacts is benefited with low profile suitable for compact and thin applications.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a contact of an electrical socket in accordance with a preferred embodiment of the present invention;

FIG. 2 is a front view of the electrical contact as shown in FIG. 1;

FIG. 3 is a bottom view of the electrical contact as shown in FIG. 1;

FIG. 4 is an isometric view of the electrical socket in accordance with the preferred embodiment of the present invention;

FIG. 5 is a cross-sectional view of an interconnect assembly of the invention for using with the electrical socket for electrically connecting a pin of an electrical package and a PCB; and

FIG. 6 is a cross-sectional view of an interconnect assembly of the invention for using with the electrical socket for electrically connecting a pin of an electrical package and a PCB.

### DETAILED DESCRIPTION OF THE PREFERRED EMBODIMENT OF THE INVENTION

Reference will now be made to the drawings to describe the present invention in detail.

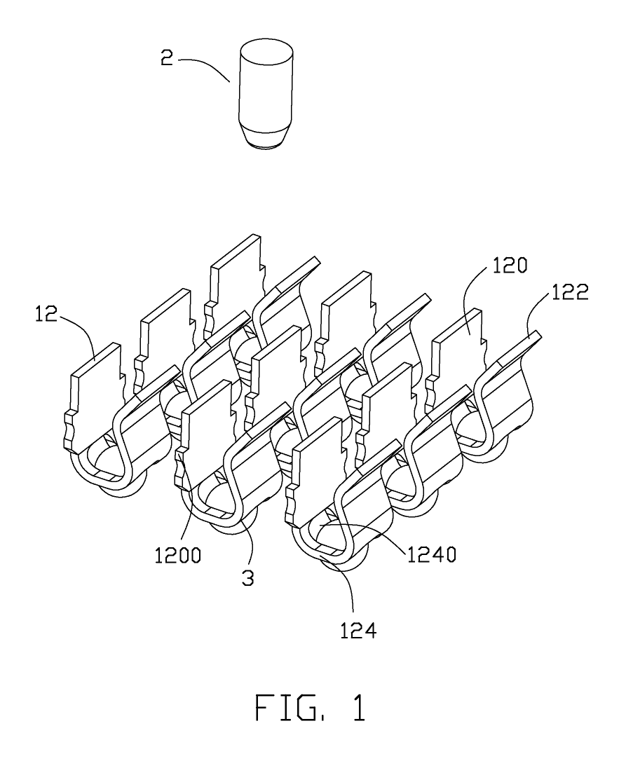

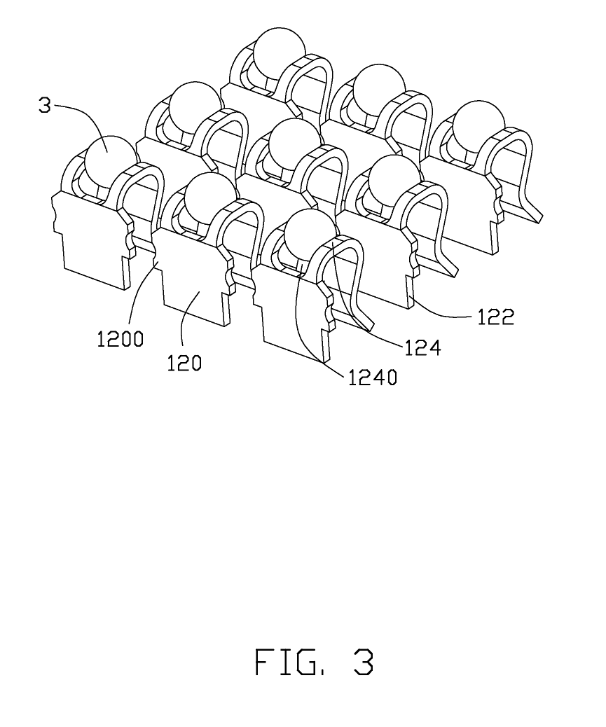

Referring to FIGS. 1-3, the contact 12 is used for electrically connecting a pin 2 leg of an electrical package (not shown) with a PCB 4 via a solder ball 3. The contact 12 includes a blade 120 serving as a first contact portion 1202 and a number of retaining portions 1200 used to physically engage with a portion of a passage of a socket connector. The contact 12 further includes a solder retaining portion 124 in which the solder ball 3 thereof. The solder retaining portion 124 is substantially orthogonal to the blade 120. The solder retaining portion 124 is located at a lowest position when the contact 12 is inserted into the passageway 100. A spring arm 122 extends from the solder retaining portion 124 and is substantially in parallel to the blade portion 120. Both the blade 120 and the spring arm 122 define a receiving space 126 in which the pin leg 2 of a CPU can be electrically disposed therein.

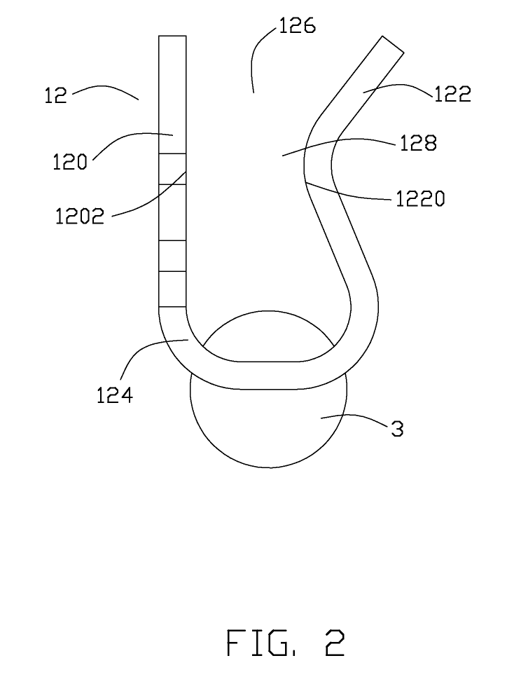

The space 126 further comprises a lead-in space 126 and a contacting space 128 disposed in turn along the vertical direction. Referring to FIG. 2, a top end of the blade 120 is substantially flush with a top end of the spring arm 122.

Referring to FIG. 1, the blade 120 has a planar surface facing the spring arm 122, the number of retaining portions 1200 being disposed on opposite edges of the blade 120. The spring arm 122 is configured with a curved structure, which has a peak 1220 projecting toward the blade. The peak 122 will contact with the pin leg 2 jointly with the first contacting point 1200 disposed on the blade 120.

Referring to FIGS. 1-3, the solder retaining portion 124 is of a curved structure and interconnects a bottom end of the blade 120 and a bottom end of the spring arm 122. Moreover, the solder retaining portion 124 defines an opening for receiving the solder ball 3 therein.

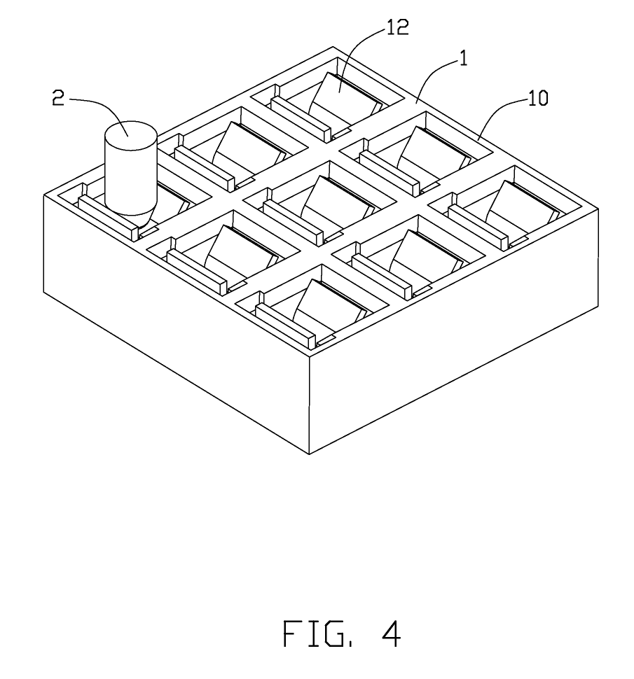

Referring to FIGS. 4-6, the electrical socket 1 in accordance with the present invention comprises an insulative housing 10 having a plurality of passageways 100, and a plurality of contacts 12 received in the passageways, respectively. The blade 120 of the contact 12 is fixed in corresponding passageway 100. The spring arm 122 moveably extends in the corresponding passageway 100. Accordingly, the contacting point 1202 on the blade forms a stationary contacting point and the peak 1220 forms a moveable contacting point.

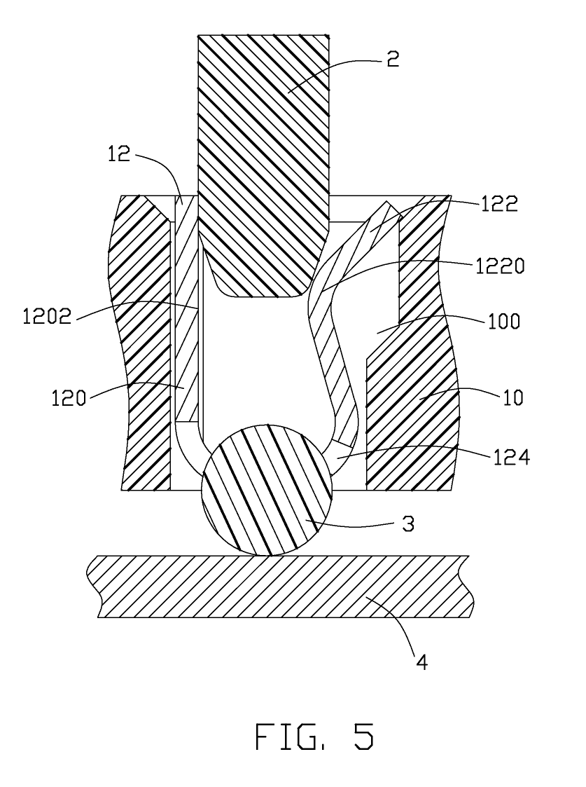

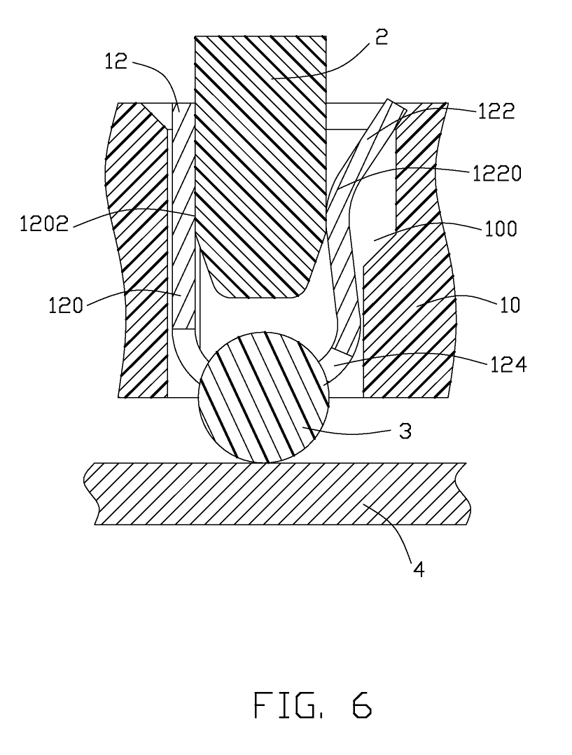

Referring to FIGS. 5-6, an interconnect assembly using the electrical socket 1 for electrically connecting the pin leg 2 to the PCB 4 via the solder ball 3 is shown. When the pin leg 2 is inserted into the space 126 defined by the blade 120 and the spring 122, the spring arm 122 will be deformed under press from the pin leg 2 and move away from blade 120. Accordingly, the peak 1220 will move away from blade 120. When the pin leg 2 is reached or located within the contacting space 128, the peak 1220 will hold the pin leg 2 in the contacting space 128 jointly with the first contacting portion 1202. Accordingly, electrical connection between the electrical socket 1 and the pin 2 leg is established.

According to the present invention, the spring arm 122 is parallel to the blade 120 so that the contact 12 has a lower height in the vertical direction. Therefore, the electrical socket 1 is benefited with low profile suitable for compact and thin applications so as to meet industry trend of miniaturization of electrical component.

While the preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical contact for interconnecting two electronic components, comprising:
a blade having a number of retaining portions thereon; and
a spring arm extending parallel to the blade and attached to the blade by a curved portion so that a contacting space is formed between the spring arm and the blade for receiving and engaging with an electronic component.

2. The electrical contact as claimed in claim 1, wherein the blade and the spring arm extend vertically.

3. The electrical contact as claimed in claim 2, wherein a top end of the blade is substantially flush with a top end of the spring arm.

4. The electrical contact as claimed in claim 3, wherein the blade is of a plate-like structure having a planar surface facing the spring arm, the retaining portions being disposed on opposite edges of the plate-like structure.

5. The electrical contact as claimed in claim 4, wherein the spring arm is configured with a curved structure, which has a peak projecting toward the blade.

6. The electrical contact as claimed in claim 1, wherein the curved portion interconnects a bottom end of the blade and a bottom end of the spring arm.

7. The electrical contact as claimed in claim 6, wherein the curved portion defines an opening.

8. An electrical socket for interconnecting two electronic components, comprising:
an insulative housing having a plurality of passageways; and
a plurality of contacts received in the passageways, respectively, each contact comprising:
a blade fixed in corresponding passageway; and
a spring arm attached to the blade by a connecting portion and moveably extending in the corresponding passageway; wherein
the spring arm is spaced from the blade so that a contacting space is formed between the spring arm and the blade for receiving and engaging with an electronic component, and so shat a fixed contacting portion is formed on the blade while a moveable contacting portion is formed on the spring arm.

9. The electrical contact as claimed in claim 8, wherein the spring arm is parallel to the blade.

10. The electrical contact as claimed in claim 9, wherein the blade and the spring arm extend vertically.

11. The electrical contact as claimed in claim 10, wherein a top end of the blade is substantially flush with a top end of the spring arm.

12. The electrical contact as claimed in claim 11, wherein the blade is of a plate-like structure having a planar surface facing the spring arm, a number of barbs being disposed on opposite edges of the plate-like structure.

13. The electrical contact as claimed in claim 11, wherein the spring arm is configured with a curved portion, which has a peak projecting toward the blade.

14. The electrical contact as claimed in claim 13, wherein the connecting portion interconnects a bottom end of the blade and a bottom end of the spring arm.

15. The electrical contact as claimed in claim 14, wherein the connecting portion defines an opening.

16. An electrical connector for use with an electronic package having pin type contacts thereon, comprising:
an insulative housing defining a plurality of passageways extending in a vertical direction through an upper surface of the housing for receiving pin type contacts of the electronic package, respectively; and
a plurality of contacts disposed in the corresponding passageways, respectively, each of the contacts defining a first arm and a second arm with a bottom portion linked between both bottom ends of the first arm and the second arm; wherein
one of the said first arm and said second arm is resilient for engagement with a pin type contact of the electronic package while the other is equipped with retention means for retaining the contact in the housing, and a solder ball is attached to the bottom portion.

17. The electrical connector as claimed in claim 16, wherein the bottom portion defines an opening through which the corresponding ball extends.

18. The electrical connector as claimed in claim 17, wherein said first arm and said second arm are spaced from each other in a first direction in a top view while the contact sandwiches the corresponding solder ball in a second direction perpendicular to said first direction in said top view.

19. The electrical connector as claimed in claim 18, wherein engagement between the contact and the pin type contact of the electronic package, essentially enhances sandwiching the solder ball.

20. The electrical connector as claimed in claim 16, wherein said one of the first arm and the second arm with resiliency thereof, defines an oblique section around a top end under condition that said oblique section is constantly seated upon an oblique surface form on the housing in the corresponding passageway.
